(19) United States
(12) Patent Application Publication
(10) Pub. No.: US 2010/0073186 A1
(43) Pub. Date: Mar. 25, 2010

(54) ARTICLE LOCATOR

(76) Inventor: Alexandra Montclare, Grants Pass, OR (US)

Correspondence Address: ITALIA IP, 3500 WEST OLIVE AVE., SUITE 300, BURBANK, CA, 91505, US

(21) Appl. No.: 12/234,354

(22) Filed: Sep. 19, 2008

(51) Int. Cl. G08B 7/00; G08B 3/00

(52) U.S. Cl. 340/692; 340/691.1

(57) ABSTRACT

A locator of personal articles being monitored to prevent loss or misplacement. The locator emits a location cue. The location cue may be emitted at the monitored article, or if in the form of a verbal message, may be generated at the person who is monitoring the personal article. Location cues emitted at the monitored article may be audible, visible, or olfactory. The locator may comprise two separate cooperating devices including a querying device and a cue emitting device, or may comprise only one device, such as for emitting the verbal message. The sole device may comprise a location cue emitter kept with the monitored article, such as for emitting an audible cue, a visible cue, or an olfactory cue.

### BACKGROUND OF THE INVENTION

1. Field of the Invention

The present invention relates to devices for enabling a person to find a personal article which is not in immediate sight.

2. Background of the Invention

One of life's frustrations is not being able to lay hands on a personal article which is known to be in the home or elsewhere in relatively close proximity to a person. Such articles may include keys, glasses, medicaments, electronic appliance controllers, cellular telephones, and pens or pencils, among many others. Such articles are typically not constantly used, but are of great importance during the relatively brief times when they are desired. The article may be very close to the person looking for it, yet hidden from view. It will be appreciated that an article that is hidden from view is effectively lost regardless of its actual proximity to the person looking for it.

The reason that the item is not found typically relates to the item being covered by another article, or alternatively that the owner or user has merely forgotten where the sought article was laid down.

Some small personal articles have built in locating capabilities. For example, some recent telephones having mobile handsets can emit sounds responsive to a command entered at the docking station. But most articles have no such inherent capabilities. There exists a need for a practical way to find a temporarily lost or misplaced article which are known to be in the general vicinity of a person looking for it.

### SUMMARY OF THE INVENTION

The present invention provides a way for a person to locate an article in his or her general vicinity, such as inside one's house. A location cue emitter is enabled to emit a location cue when desired. The location cue emitter may be for example an odor emitter coupled to an article to be protected from temporary loss. The location cue emitter may be operated actively by a signal generated by the person looking for the article, or alternatively automatically. Illustratively, an article which is predictably needed at specific times may be programmed to use an internal timer to emit the cue. The location cue emitter may be motion sensitive and emit a location cue responsive to detecting motion. In one aspect of the invention, motion sensing may be used together with a timer. For example, moving the article may start a timing sequence which after a predetermined period of elapsed time, the location cue is emitted.

The location cue may be any sensed phenomenon, such as audible, visible, olfactory, and vibrating, among others.

coupled to an article which is to be protected.

It is important to note that a locator according to at least one aspect of the invention need not determine the location, for example in the sense that a Global Positioning System (GPS) is able to locate a monitored device. The locator merely need emit a sensible signal that will enable the human operator to locate the monitored article.

The article locator may be self-contained and operate automatically or responsively to its environment, such as by detecting motion, or may have a component which is maintained with the person using the locator and operate by command.

Articles to be protected may comprise keys, glasses, medicaments, medical devices, electronic device controllers, communications devices, hearing aids, jewelry, and others.

It is an object of the invention to provide a personal article locator which can emit a location cue signaling location of a sought article.

It is another object of the invention to provide an article locator having personalized operating characteristics.

A further object of the invention is to provide an article locator which is versatile in its functions such that it can operate automatically when desired, or by command when desired.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic view of an article locator according to at least one aspect of the invention, and a wallet to be monitored by the article locator.

FIG. 2 is an environmental side view of an article locator according to at least a further aspect of the invention.

FIG. 3 is an enlarged detail view showing internal components of the locator of FIG. 2.

FIG. 4 is a block diagram of steps of a method of using an article locator such as the article locator of FIG. 2.

FIG. 5 is a diagrammatic view of an article locator according to at least one further aspect of the invention.

FIG. 6 is a diagrammatic view of an article locator according to at least a still further aspect of the invention.

### DETAILED DESCRIPTION

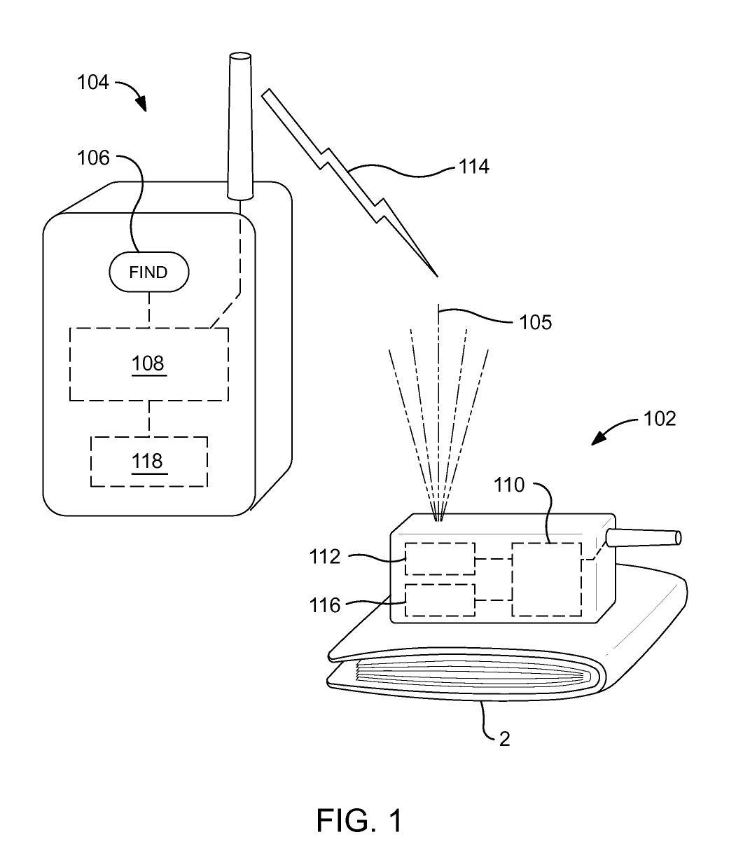

FIG. 1 shows a locator 100 for personal articles such as a wallet 2 according to one aspect of the invention. The locator 100 may comprise two separate components, such as a location cue emitter 102, and a remote signal generator 104 disposed to enter a radiant energy command signal to the location cue emitter 102. As employed herein, the term “remote” will be understood to refer to a component which is physically separate and is intended to be operable when it and the component with which it communicates are separated and apart from one another, and does not necessarily imply a great or significant distance of separation. It is possible for an article such as the wallet 2 to be quite close to the remote signal generator 104 yet still out of sight and effectively lost to its owner.

The remote signal generator 104 may be carried on the person of the user, and may be actuated whenever it is desired to locate the monitored personal article. The personal signal generator is of dimensions and configuration to be hand held, and may be sufficiently compact so as to be carried in a pocket, strapped to a belt (not shown), or otherwise carried in the user's apparel. Alternatively, the remote signal generator 104 may engage the body of the user, for example, by having a body encircling band or other tether (none shown).

The remote signal generator 104 may include a remote command signal generator disposed to enter a radiant energy command signal to the location cue emitter 102, and a pushbutton operated switch 106 for actuation. One possible type of radiant energy command signal generator is a radio frequency transmitter 108. Of course, other forms of radiant energy signals may be substituted, such as infrared, acoustic signals including audible and ultrasonic, ultraviolet, low frequency vibratory, and others.

The radio frequency transmitter 108 of the body carried remote signal generator 104 communicates with a radio frequency receiver 110 which is part of the location cue emitter 102. Receipt of a predetermined radio frequency signal actuates the location cue emitter 102 to emit a cue to the person operating the locator 100. The location cue emitter 102 may include a device disposed to eject a scented aerosol, seen as a spray 105. Such a device may be regarded as an odor emitter 112. The scented aerosol may be regarded as an olfactory signal.

The user may then use the olfactory sense to sense the location of the wallet 2 by strength of the olfactory signal.

The odor emitter 112 may comprise a solenoid coupled to a plunger arranged to discharge a preloaded aerosol material (these subcomponents are not separately shown).

The precise nature of the odor emitter 112 is not critical to the invention. If a sufficiently volatile olfactory substance is employed, the odor emitter 112 may have a closure (not shown) which is operated responsively to the radio frequency signal 114 which is transmitted by the radio frequency transmitter 108. The closure may be opened to expose the volatile olfactory substance to ambient air. The closure may comprise a material which distends or separates responsively to application of voltage, for example. Power for operating the odor emitter 112 may be contained within a battery cell 116 carried aboard the location cue emitter 102. Alternatively, the location cue emitter 102 may comprise a device which obtains operating power from the radio frequency signal 114. The remote signal generator 104 may have its own battery cell 118.

Because the precise circuitry of the locator 100 is not critical to the invention, circuitry is shown in abbreviated form. That is, circuitry will be understood to comprise the number of conductors, and specific connection schemes necessary to carry out the described functions, as well as supporting apparatus such as switches, relays, transducers, circuit breakers, transformers, and voltage dividers, among others.

The remote signal generator 104 may be carried in apparel, such as within a pocket (not shown), may be tethered, connected, attached, or adhered to the user's body (tether, connecting structure, adhesive, and body attaching structure are not shown), or may be hand held. The remote signal generator 104 may be dimensioned and outwardly configured in the manner of a cellular phone, for example.

The location cue emitter 102 may be quite small, such as being dimensioned and configured to be hand held, so that it is not objectionably bulky when placed with the article being monitored as to location, such as the wallet 2. Miniaturized components are available to fabricate such a location cue emitter 102.

In summary, the locator 100 may comprise an indicator signal generator such as the odor emitter 112, which is disposed to emit a sensible signal responsive to a radiant energy command signal, such as the radio frequency signal 114, which transmitted to the location cue emitter 102, and a remote signal generator such as the remote signal generator 104.

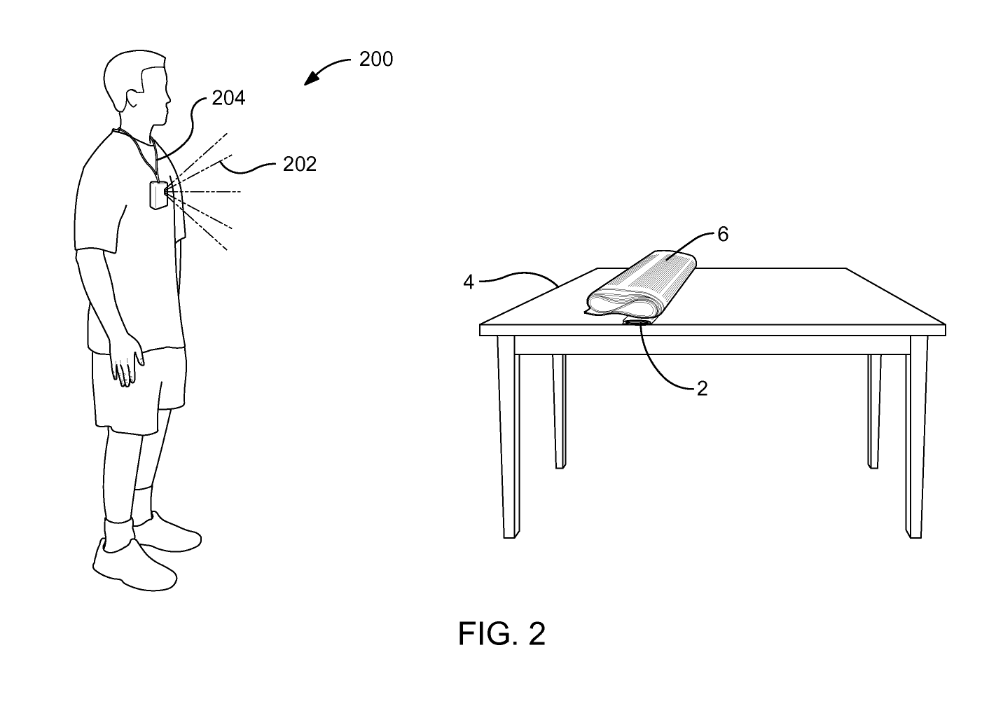

FIG. 2 shows a locator system 200 which locates a lost personal article such as the wallet 2, which in this example has been concealed on a table 4 beneath a newspaper 6. The locator system 200 signals the location of the wallet 2 by emitting audible speech, the latter being represented by the numeral 202.

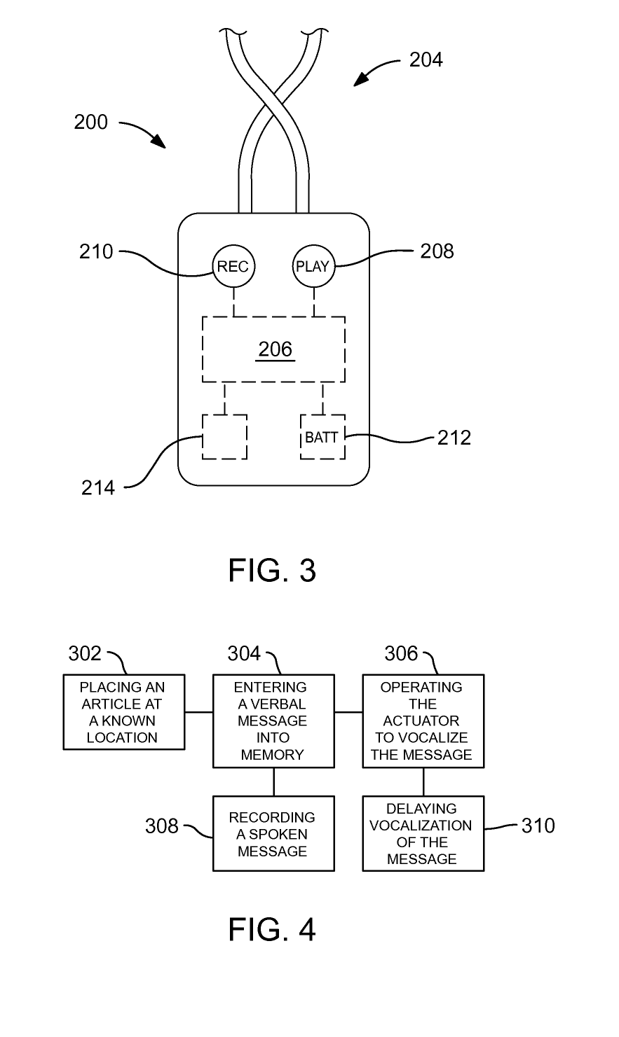

The locator system 200 may be body carried, for example by suspending the locator system 200 from the neck of the user by a cord 204. Referring also to FIG. 3, the locator system 200 comprises a memory device, a speech synthesizer, an actuator disposed to cause the speech synthesizer to reproduce a verbal message which is contained within the memory device, and a control circuit to implement the described functions. In the example of FIGS. 2 and 3, the memory device and speech synthesizer functions are provided by a magnetic tape recorder 206. The actuator may comprise a pushbutton switch 208 which in this example causes the magnetic tape recorder 206 to play recorded messages. The actuator of the locator system 200 may comprise a second pushbutton switch 210 which controls the magnetic tape recorder 206 to record a new message.

A miniature battery 212 may be incorporated into the locator system 200 to provide operating power.

The control circuit may include a timing subcircuit 214 which, upon pushing the pushbutton switch 208 to activate the locator system 200, counts down a predetermined time delay period and activates the audible message reproduction function after the predetermined time delay period has been counted down. The timing subcircuit 214 may be similar to those provided for alarm clocks and similar devices.

The locator system 200 may be employed by pressing the “play” pushbutton switch 208 so that a verbal message which reminds the user where he or she has placed the monitored personal article is played. In the example of FIG. 2, it may be that the user has placed the wallet 2 on the table 4, and carelessly placed the newspaper 6 over the wallet without realizing it. The user may, upon placing the wallet 2 on the table 4, record a message such as “The wallet is on the table”. When replaying the message, the user will know to remove the newspaper 6 to retrieve the wallet 2.

The combination of audible message replay and timing features would not only remind the user of the whereabouts of the monitored personal article, but would also allow the user to locate the locator system 200 if that has been misplaced. Further the the timing feature would conveniently would serve as a reminder that it is time to perform a particular task associated with the monitored article. Alternatively stated, the locator system 200 may combine the functions of a locator, a locator system with a location mechanism in its own right, and also an alarm clock (not shown) or the like.

The invention may be considered a method 300 of monitoring and subsequently locating a personal article. As reflected in summary in FIG. 4, the method 300 may comprise a step 302 of placing a personal item at a known location within premises; a step 304 of entering into the memory device of a device such as the locator system 200 a verbal message indicative of the known location; and a step 306 of operating the actuator to vocalize the verbal message when it is desired to be reminded of the location of the personal article.

The step 304 of entering into the memory device a verbal message indicative of the known location may comprise a further step 308 of speaking the verbal message and recording the verbal message. The step 306 of operating the actuator may comprise a further step 310 of delaying vocalization of the stored verbal message until a predetermined time period has elapsed.

It should be understood that due to the conceptual description presented herein, components presented in the singular may be provided in the plural. Where feasible, it would be possible to provide a single component rather than a plurality of components. For example, the actuator function provided by the pushbutton switch 208 may be provided by a single controller which selectively initiates the functions of both the pushbutton switch 208 and also that of the pushbutton switch 210, and possibly additional functions of the type traditionally associated with tape recorders.

It would be possible to replace the tape recorder 206 with a digital system if desired. For example, the verbal message may be digitized and stored on a memory device. The verbal message may be reproduced on a speech synthesizer of a known type that produces synthetic voice.

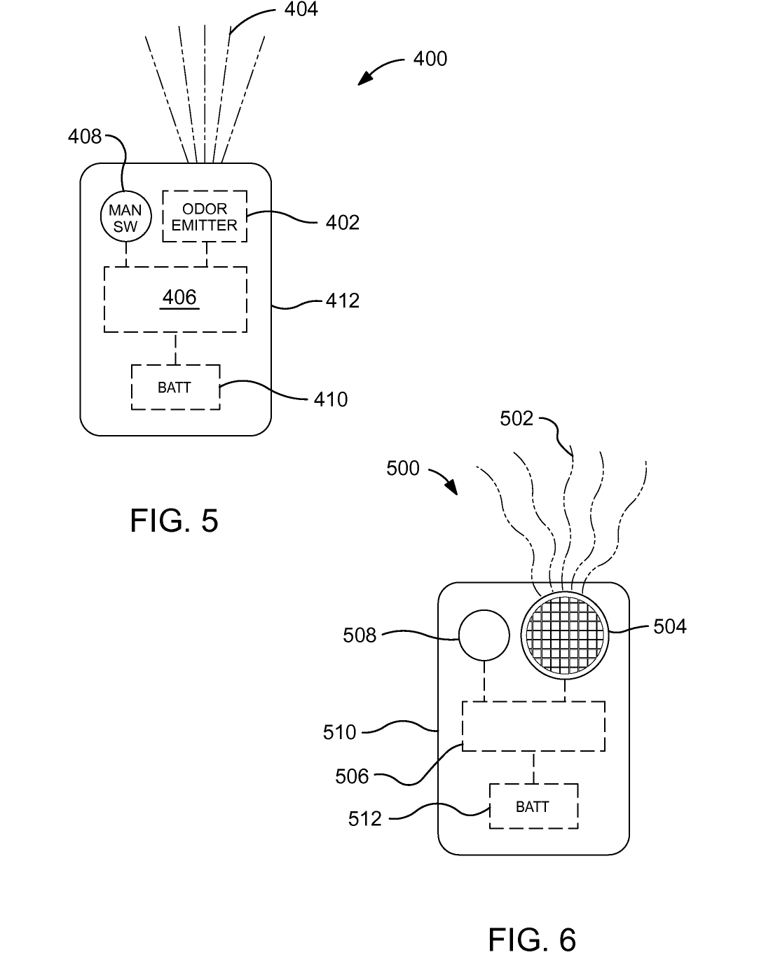

Referring now to FIG. 5, according to a further aspect of the invention, a location cue emitter 400 is shown. The location cue emitter 400 is disposed to emit a sensible signal to annunciate location of a personal article, such as the wallet 2. The location cue emitter 400 may comprise an odor emitter 402 disposed to emit an olfactory signal 404. The odor emitter 402 may be similar in operation or structure or both to the odor emitter 112 of FIG. 1. The location cue emitter 400 may comprise a control circuit disposed to operate the odor emitter 402 to emit the olfactory signal 404, wherein the control circuit comprises a timing subcircuit 406 subcircuit disposed to automatically operate the odor emitter 402 after a predetermined time period has been counted down.

A manual switch 408 which is accessible at the exterior of the location cue emitter 400 is disposed to cause the timing subcircuit 406 to restart the countdown of the predetermined time period and to operate the odor emitter 402 upon expiration of the predetermined time period.

A battery 410 may be incorporated into the location cue emitter 400 to provide operating power.

The above components may be contained within a housing 412 which is dimensioned and configured to be hand held.

FIG. 6 shows a location cue emitter 500 disposed to emit a sensible signal 502 to annunciate location of a personal article such as the wallet 2. The location cue emitter 500 may comprise a sensible signal emitter 504 disposed to emit the sensible signal 502, and a control circuit disposed to operate the sensible signal emitter 504 to emit the sensory signal 502. The control circuit may comprise a timing subcircuit 506 and a motion detector 508 disposed to automatically operate the sensible signal emitter after a predetermined time period has been counted down by the timing subcircuit 506. The motion detector 508 may serve as a restart operator disposed to restart the countdown of the predetermined time period in the manner of the manual switch 408 of FIG. 5.

It should be noted that the control circuit is arranged to be constantly counting down the predetermined time period, and is disposed always to automatically operate the sensible signal emitter 504 unless the motion detector 506 operates to restart the countdown of the predetermined time period.

An example of use of the motion detector 506 will be presented. If used for a personal article such as the wallet 2 of FIG. 1, carrying the wallet 2 about or moving the wallet 2 will inhibit the start of the countdown. However, when the wallet 2 is laid to rest, the motion detector 506 may send a signal to the timing subcircuit 506, which will result in the timing subcircuit starting a new countdown. After the countdown is completed, the sensible signal emitter 504 will then operate. No querying device, such as the remote signal generator 104 of FIG. 1, is necessary.

Power may be supplied by a battery 512.

The components of the location cue emitter 500 may be contained within a housing 510 which is dimensioned and configured to be hand held.

The sensible signal emitter 504 may comprise a buzzer or any generator of an audible signal, a lamp or any generator of a visible signal, or an olfactory signal generator, such as of the type described with respect to FIG. 1.

The locators 100, 200, 400, and 500 may be provided with on-off switches to inhibit operation, for example, to conserve battery power, if desired.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A locator for personal articles, comprising a location cue emitter of dimensions and configuration to be hand held, having an odor emitter disposed to emit an olfactory signal responsive to a radiant energy command signal transmitted to the location cue emitter, and a remote signal generator disposed to emit a radiant energy command signal to the odor emitter.

2. The locator of claim 1, wherein the remote signal generator is of dimensions and configuration to be hand held.

3. A method of signalling the location of a personal article in the form of audible speech, comprising the steps of:
carrying on a person's body a speech emitter comprising a memory device, a speech synthesizer, an actuator disposed to cause the speech synthesizer to reproduce a verbal message contained within the memory device, and a timing circuit disposed to operate the actuator after a predetermined time period;
placing a personal item at a known location within premises;
entering into the memory device a verbal message indicative of the known location;
pressing the switch key on the body carried speech emitter to cause the timing circuit to countdown the predetermined time period; and
reproducing the verbal message from the memory device after the predetermined time period has counted down.

4. The method of claim 3, wherein the step of recording into the memory device a verbal message comprises the further step of speaking the verbal message and recording the spoken verbal message using the memory device of the speech emitter.

5. A location cue emitter disposed to emit a sensible signal to annunciate location of a personal article, comprising:
a sensible signal emitter disposed to emit a sensible signal; and
a control circuit disposed to operate the sensible signal emitter to emit the sensory signal, wherein the control circuit comprises a timing subcircuit disposed to automatically operate the sensible signal emitter after a predetermined time period has been counted down, and a restart operator disposed to restart the countdown of the predetermined time period, wherein the control circuit is constantly counting down the predetermined time period and is disposed always to automatically operate the sensible signal emitter unless the restart operator operates to restart the countdown of the predetermined time period.

6. The location cue emitter of claim 5, wherein the restart operator comprises a manual switch which is accessible at the exterior of the location cue emitter, wherein the manual switch is operably connected to the timing subcircuit to restart the countdown responsive to the switch being operated.

7. The location cue emitter of claim 5, wherein the restart operator comprises a motion detector which is operably connected to the timing subcircuit to restart the countdown responsive to detecting motion.

8. The location cue emitter of claim 5, wherein the sensible signal emitter is disposed to emit an audible signal.

9. The location cue emitter of claim 5, wherein the sensible signal emitter is disposed to emit a visible signal.

10. The location cue emitter of claim 5, wherein the sensible signal emitter is disposed to emit an olfactory signal.
